(19) United States
(12) Patent Application Publication
(10) Pub. No.: US 2024/0303340 A1
(43) Pub. Date: Sep. 12, 2024

(54) AUTOMATIC MITIGATION OF BIOS ATTACKS

(71) Applicant: DELL PRODUCTS L.P., Round Rock, TX (US)

(72) Inventors: Marc N. McGarry, Kernersville, NC (US); Nizar A. Basan, Garland, TX (US); Weiqing Cai, Dallas, TX (US)

(21) Appl. No.: 18/180,455

(22) Filed: Mar. 8, 2023

(51) Int. Cl. G06F 21/57; G06F 21/55

(52) U.S. Cl. CPC G06F 21/572; G06F 21/554; G06F 2221/034

(57) ABSTRACT

An information handling system instantiates a system health monitor that detects a change to an attribute of the information handling system from a first state to a second state, compares the change to a policy related to the attribute, and remediates the change in response to determining that the change is critical.

### FIELD OF THE DISCLOSURE

This disclosure generally relates to information handling systems, and more particularly relates to providing the automatic mitigation of BIOS attacks in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a memory device configured to store code, and a processor configured to execute code. The processor may instantiate a system health monitor that detects a change to an attribute of the information handling system from a first state to a second state, compares the change to a policy related to the attribute, determines that the change is a critical change based upon the comparison, and remediates the change in response to determining that the change is the critical change.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is an illustration of an information handling system according to an embodiment of the current disclosure;

FIG. 2 is a process flow chart whereby a verification agent determines whether or not an event (that is, an attribute change) constitutes a threat according to an embodiment of the current disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application.

The teachings can also be used in other applications, and with several different types of architectures as needed or desired.

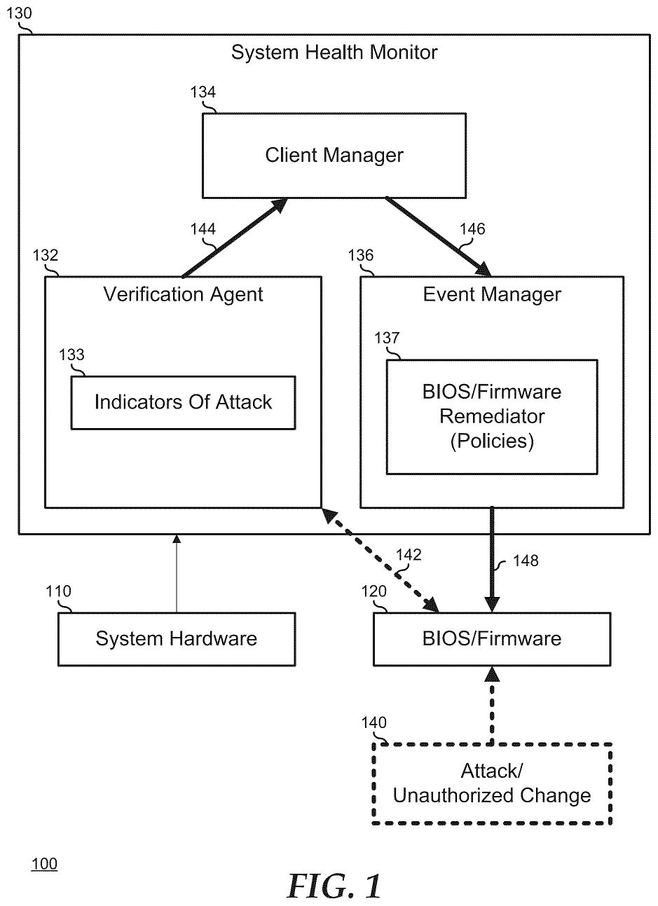

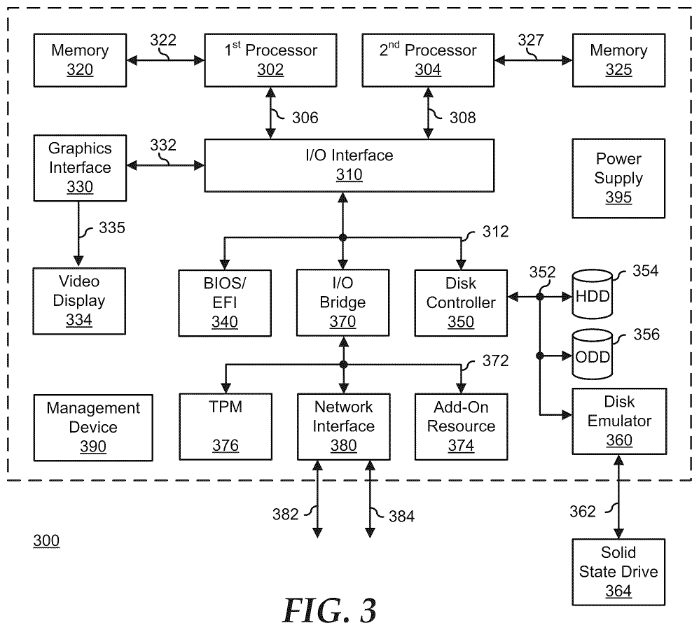

FIG. 1 illustrates an information handling system 100 including system hardware 110 and system BIOS/firmware 120. Information handling system 100 represents a processing system similar to information handling system 300, as described in FIG. 3, below. System hardware 110 represents the hardware elements of information handling system 100, and BIOS/firmware 120 represents the basic operating code that is executed on the system hardware to initialized the information handling system, set up the system hardware, launch the various services needed for the basic operation of the information handling system, as needed or desired. As such, BIOS/firmware 120 may be understood to include Universal Extensible Firmware Interface (UEFI) code, operating system code, BIOS ROM, or other code that may be utilized in the initialization and operation of information handling system 100.

The inventors of the current disclosure have recognized that BIOS/firmware 120 is routinely updated, for example by installing updates or by setting various BIOS/firmware setting to provide greater performance of information handling system 100, or to prevent malicious activities from being performed on the information handling system. Given the complex array of elements within a typical information handling system, complex BIOS/firmware may require frequent updating, and the ramifications on an update on one element may not be fully understood, leaving various exploits that can be taken advantage of by malicious actors.

Particular attacks may seek to change BIOS/firmware 120 in order to expose information handling system 100 to more potential exploits. For example, malicious actors may seek to install malicious versions of the various elements of BIOS/firmware 120, to set various settings within the BIOS/firmware, or to otherwise tamper with the BIOS/firmware.

Information handling system 100 includes a system health monitor 130. In particular, system health monitor 130 represents a framework for monitoring the health of information handling system 100 that is instantiated on system hardware 110. In this regard, system health monitor 130 may represent one or more program, application, utility, or the like that operates at system start up and during run time to monitor the health of system hardware 110 and of BIOS/firmware 120. In monitoring the health of system hardware 110 and of BIOS/firmware 120, system health monitor 130 operates to validate the various devices included in the system hardware to ensure that the physical devices have not been tampered with. The details of monitoring system hardware are known in the art, and will not be further described herein, except as may be needed to illustrate the current embodiments.

In monitoring the health of BIOS/firmware 120, system health monitor 130 operates to detect the versions of the various elements of the BIOS/firmware, such as by comparing checksums or hashes of the current elements with the checksums of hashes for known good versions of the elements, or the like. Additionally, system health monitor 130 operates to compare the settings for the elements of BIOS/firmware 120 with the desired settings. In particular, system health monitor 130 operates to monitor various preferred settings, important settings, critical settings, or other categories of settings, as needed or desired. Preferred settings may include settings that are provided to establish logging levels, or the like, and that do not otherwise affect the performance of information handling system 100. Important setting may include settings that are provided to govern the performance level of information handling system 100, that provide minimum logging levels, or the like, and that affect the operations of information handling system 100. Critical settings may include settings that impact safety or security of the operation of information handling system 100, such as thermal and electrical settings, Secure Boot settings, or other safety and security settings. Moreover, system health monitor 130 operates to monitor the health of information handling system 100 during power on operations, and during run time operations.

As a final aspect of the monitoring of the health of system hardware 110 and BIOS/firmware 120, system health monitor 130 operates to provide indications of the health of the system hardware and the BIOS/firmware. In a first aspect, system health monitor 130 operates to provide event logging of the health of system hardware 110 and BIOS/firmware 120.

When any element of system hardware 110 or of BIOS/firmware 120 exhibit discrepancies, system health monitor 130 operates to provide a data log of the discrepancies, and to provide an indication, for example, to a management system of a data center, describing the discrepancies, as needed or desired. In another aspect, system health monitor 130 operates to provide internal communications of any discrepancies, in order for the system health monitor to attempt to mitigate the discrepancies, as described further below. In particular, system health monitor 130 includes various sub-processes, as described below. System health monitor 130 provides for internal communications between the sub-processes, such as by providing a framework for inter-process communication (IPC), as needed or desired.

In addition to monitoring the health of system hardware 110 and of BIOS/firmware 120, system health monitor 130 operates to maintain the health of information handling system 100. In particular, system health monitor 130 operates to act on any discrepancies in BIOS/firmware 120 to remediate the discrepancies and to restore the BIOS/firmware to its original state, as described further below. An example of system health monitor 130 may include a Dell Tech Hub framework or the like. In a particular embodiment, system health monitor 130 is instantiated by a processor associated with a hosted environment of information handling system 100, such as may be associated with BIOS/firmware 120, an operating system instantiated on the hosted environment, or applications or programs instantiated on the hosted environment. In another embodiment, system health monitor 130 is instantiated by a management processor of information handling system 100 that operates out-of-band from the hosted environment instantiated on system hardware 110, such as a baseboard management controller or the like.

System health monitor 130 includes a verification agent 132, a client manager 134, and an event manager 136. Verification agent 132 represents a plug-in to system health monitor 130 that provides the monitoring of BIOS/firmware 120. In particular, verification agent 132 monitors BIOS/firmware for indicators of attack (IoA) 133, monitoring all BIOS and firmware attributes to determine if any of the attributes have been changed. In a particular embodiment, the BIOS and firmware attributes are actively polled, and the results compared with IoA 133. Such poling can be performed at a pre-determined interval. In another embodiment, a trap can be set for the BIOS and firmware attributes, such that, whenever an attribute is changed, the change is flagged to verification agent 132, and the change is compared with IoA 133. An example of a verification agent may include a Dell Trusted Device (DTD) plug in.

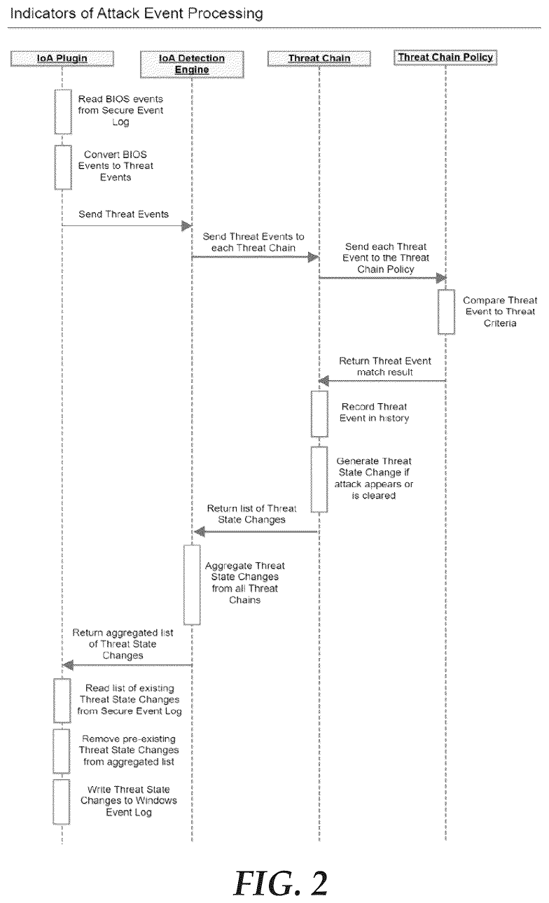

FIG. 2 illustrates a process flow where by verification agent 132 determines whether or not an event (that is, an attribute change) constitutes a threat. Verification agent 132 is shown to include an IoA plug in, an IoA detection engine, a threat chain analysis engine, and a threat chain policy engine. The IoA plug in reads BIOS and firmware events from a secure event log, converts the BIOS and firmware event logs to threat events for transmission via IPC to the other elements of system health monitor 130, and send the threat events to IoA detection engine. The threat events may be organized based upon a common BIOS or firmware attribute or set of attributes that are related. Such related threat events will be categorized as event chains. As such, the IoA detection engine groups the threat events into threat chains and forwards the threat chains for evaluation through the threat chain analysis engine to the threat chain policy engine. The threat chain policy engine compares the threat events associated with each threat change with a predetermined policy for the associated attribute or group of attributes to determine if the threat chain represents a change to a preferred attribute, an important attribute, or a critical attribute.

After the threat chain policy engine determines the severity of the threat events, the matched (or ranked) results are returned to the threat chain analysis engine to record the threat severity in a threat history, and to generate a threat state change indication which is forwarded to the IoA detection engine. The IoA detection engine aggregates the threat state changes for all of the threat chains and forwards the aggregated threat state changes back to the IoA plug in. The IoA plug in compares the aggregated list of threat state changes with previously logged threat state changes and removes pre-existing threat state changes form the list before logging the threat state changes to the event log as verified threat state changes.

Each time verification agent 132 detects a threat state change in BIOS/firmware 120, the verification agent issues a threat event indication to client manager 134. Client manager 134 represents a module of system health monitor 130 that operates to manage the IPC actions between the elements of the system health monitor. As such, the various elements may register with client manager 134 to receive notifications of various system health related events detected by system health monitor 130. The threat event indication includes descriptive information related to the detected threat state change, including an attack name, a list of attributes that need to be reverted to the safe state, the expected safe value of the attributes, details of the attack such as the time and duration of the attack, the source of the attack, whether the attack was a partial attack or a full attack, or the like. An example of client manager 134 may include a Dell Client Framework (DCF).

Event manager 136 represents an outward-facing element of system health monitor 130. In this regard, event manager 136 operates to provide interactions with the various system logs of information handling system 100. Event manager 136 further operates to remediate the threat state changes detected by verification agent. Event manager 136 registers with event manager 134 to receive the threat event indications from client manager 134. When event manager 136 receives a threat event indication, a BIOS/firmware remediator 137 extracts the attack details from the threat event indication and analyzes the details to determine how to restore the attributes to mitigate the attack. BIOS/firmware remediator 137 filters the attack details through an exclusion list that implements policies related to the attributes under attack. The polices specify, for example, whether partial attacks are processed, whether full attacks are processed, whether processing requires a reboot of information handling system 100, other attributes that may need to be checked or altered in association with the changed attributes, and the like.

If the attack should not be processed based on the policy, event manager 136 reports an exclusion event back to client manager 134 so that, for example, an administrator can review the attack. Otherwise, for each attribute included in the attack details, event manager 136 calls a BIOS/firmware API to determine if the attribute can and should be changed. If the BIOS/firmware API indicates that the attribute is currently in a safe state, event manager 136 reports a no-change-needed event back to client manager 134 for review by an administrator. The no-change-needed event may indicate that the attack was completed and the attribute was reverted prior to the involvement of event manager 136. If the BIOS/firmware API indicates that the attribute is currently in an unsafe state, then event manager 136 calls the BIOS/firmware API to change the specified attribute back to the value it contained prior to the attack.

If event manager 136 is able to change the attribute back to a safe state, the client manager reports a successful remediation event back to client manager 134. On the other hand, if event manager 136 is unable to change the attribute back to the safe state, the event manager raises an exception to client manager 134 to report that the attribute was unable to be changed, for example, for review by an administrator. Typically, when any BIOS/firmware attributes are changed by event manager 136, the event manager will reboot information handling system 100 in order to ensure the stability and performance of the information handling system. Various policies may be enacted related to the reboot of information handling system 100, such as providing for the immediate reboot, providing for reboot at a particular time, such as during an off-peak usage of the information handling system, or the like, or providing for no reboot without the intervention of an administrator. Event manager 134 operates to communicate the reboot policy to users of information handling system 100 and to an administrator, as needed or desired. In the cases where the reboot of information handling system 100 is performed automatically, event manager 136 operates to perform the reboot.

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320 and 325, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 335 to a video display 334. In a particular embodiment, information handling system 300 includes separate memories that are dedicated to each of processors 302 and 304 via separate memory interfaces. An example of memories 320 and 325 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on a separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 includes a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a memory device configured to store code; and
a processor configured to execute the code to instantiate a system health monitor, the system health monitor configured to:
detect a first change to a first attribute of the information handling system from a first state to a second state;
compare the first change to a policy related to the first attribute;
determine that the first change is a critical change based upon the comparison; and
remediate the first change in response to determining that the first change is the critical change.

2. The information handling system of claim 1, wherein in remediating the first change, the system health monitor is further configured to attempt to restore the first attribute to the first state.

3. The information handling system of claim 2, wherein the system health monitor is further configured to:
determine that the attempt to restore the first attribute to the first state was successful; and
provide an indication that the attempt to restore the first attribute to the first state was successful.

4. The information handling system of claim 3, wherein the system health monitor is further configured to reboot the information handling system after the first attribute is restored to the first state.

5. The information handling system of claim 2, wherein the system health monitor is further configured to:
determine that the attempt to restore the first attribute to the first state was unsuccessful; and
provide an indication that the attempt to restore the first attribute to the first state was unsuccessful.

6. The information handling system of claim 2, wherein the system health monitor is further configured to:
determine that the first change is a preferred change based upon the comparison; and
provide an indication that the change to the first attribute is the preferred change in response to determining that the first change is the preferred change.

7. The information handling system of claim 1, wherein the system health monitor is further configured to:
detect a second change to a second attribute of the information handling system from a third state to a fourth state, wherein the policy further relates to the second attribute;
compare the second change to the policy;
determine that the second change is a critical change based upon the comparison; and
remediate the second change in response to determining that the second change is the critical change.

8. The information handling system of claim 1, wherein the first attribute is associated with one of a basic input/output system of the information handling system and firmware of the information handling system.

9. The information handling system of claim 1, wherein the processor is associated with a hosted environment instantiated on the information handling system.

10. The information handling system of claim 1, wherein the processor is associated with a baseboard management controller of the information handling system.

11. A method, comprising:
instantiating, by a processor, a system health monitor;
detecting, by the system health monitor, a first change to a first attribute of an information handling system from a first state to a second state;
comparing the first change to a policy related to the first attribute;
determining that the first change is a critical change based upon the comparison; and
remediating the first change in response to determining that the first change is the critical change.

12. The method of claim 11, wherein in remediating the first change, the method further comprises attempting, by the system health monitor, to restore the first attribute to the first state.

13. The method of claim 12, further comprising:
determining, by the system healthy monitor, that the attempt to restore the first attribute to the first state was successful; and
providing an indication that the attempt to restore the first attribute to the first state was successful.

14. The method of claim 13, further comprising rebooting, by the system health monitor, the information handling system after the first attribute is restored to the first state.

15. The method of claim 12, further comprising:
determining, by the system health monitor, that the attempt to restore the first attribute to the first state was unsuccessful; and
providing an indication that the attempt to restore the first attribute to the first state was unsuccessful.

16. The method of claim 12, further comprising:
determining, by the system health monitor, that the first change is a preferred change based upon the comparison; and
providing an indication that the change to the first attribute is the preferred change in response to determining that the first change is the preferred change.

17. The method of claim 11, further comprising:
detecting, by the system health monitor, a second change to a second attribute of the information handling system from a third state to a fourth state, wherein the policy further relates to the second attribute;
comparing the second change to the policy;
determining that the second change is a critical change based upon the comparison; and
remediating the second change in response to determining that the second change is the critical change.

18. The method of claim 11, wherein the first attribute is associated with one of a basic input/output System of the information handling system and firmware of the information handling system.

19. The method of claim 11, wherein the processor is associated with one of a hosted environment instantiated on the information handling system, and a baseboard management controller of the information handling system.

20. An information handling system, comprising:
a memory configured to store code; and
a processor configured to execute the code to instantiate a system health monitor, the system health monitor configured to:
detect a first change to a first attribute of the information handling system from a first state to a second state from an attack on the information handling system;
compare the first change to a policy related to the first attribute; and
remediate the first change in response to determining that the first change is a critical change.
